(19) United States
(12) Patent Application Publication
(10) Pub. No.: US 2018/0238113 A1
(43) Pub. Date: Aug. 23, 2018

(54) LADDER STORAGE RECEPTACLE

(71) Applicant: Patrick Wulfekotte, Brick, NJ (US)

(72) Inventor: Patrick Wulfekotte, Brick, NJ (US)

(21) Appl. No.: 15/900,686

(22) Filed: Feb. 20, 2018

Related U.S. Application Data
(60) Provisional application No. 62/461,189, filed on Feb. 20, 2017.

(51) Int. Cl. E06C 7/14; E06C 1/20; B25H 3/06

(52) U.S. Cl. CPC E06C 7/14; B25H 3/06; E06C 1/20

(57) ABSTRACT

A storage-receptacle for attachment to a ladder; the storage-receptacle includes a tray-housing having a tray-capacity, four tray-sides, a tray-base and an open-top; and an attachment-means fixedly-attached to one of the four tray-sides configured to secure the storage-receptacle to a top-step of the ladder. The storage-receptacle is useful for providing easily accessible tools for a user.

### CROSS REFERENCE TO RELATED APPLICATION

The present application is related to and claims priority to U.S. Provisional Patent Application No. 62/461,189 filed Feb. 20, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of receptacles and more specifically relates to a storage receptacle for attachment to a ladder.

### 2. Description of Related Art

Ladders usually contain a top platform, or top step that is used for providing structural integrity to the ladder and is not used for stepping. When a user works at the top of the ladder, the user often finds that picking up extra supplies or tools from the ground level is time consuming and inefficient. People may try to hold multiple tools in their hands, or in their pockets, only to put themselves in a dangerous situation when climbing the ladder. People may also try to store tools and materials on the top rung of the ladder; however, the tools/materials could easily be knocked off and serious injury and/or messed would occur. Thus, a suitable solution is desired.

U.S. Pat. No. 5,603,405 to William H. Smith relates to a ladder top storage rack. The described ladder top storage rack includes a rigid tool box haying securable to a ladder top. A pair of side pouches is secured to two side walls of the tool box. Each of the side pouches has a zippered opening. A rear pouch is secured to the rear wall of the tool box. The rear pouch has a zippered opening.

### BRIEF SUMMARY OF THE INVENTION

In view of the foregoing disadvantages inherent in the known receptacles art, the present disclosure provides a novel ladder storage receptacle. The general purpose of the present disclosure, which will be described subsequently in greater detail, is to provide a storage receptacle for attachment to a ladder to provide easily accessible tools for a user.

A storage-receptacle is disclosed herein. The storage-receptacle may be used for attachment to a ladder and the ladder may include a plurality of steps having at least one top-step. The storage-receptacle includes a tray-housing which may include a tray-capacity defined by at least four tray-sides, a tray-base and an open-top opposite the tray-base and relative to the ladder; the tray-capacity being configured to store a plurality of items therein. Further, an attachment-means may be fixedly-attached to one of the at least four tray-sides, the attachment-means may include at least four attachment-sides, an attachment-top and an open-bottom opposite the attachment-top and relative to the ladder and the open-bottom may be configured for securement over the at least one top-step.

A method of using the storage-receptacle is also disclosed herein. The method of using the storage-receptacle may comprise the steps of: providing the storage-receptacle as above; securing the attachment-means over the at least one top-step of the ladder via the open-bottom; removably-placing at least one of the plurality of items into the tray capacity of the tray-housing; climbing the plurality of steps of the ladder; and using the at least one of the plurality of items whilst on the ladder.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a ladder storage receptacle, constructed and operative according to the teachings of the present disclosure.

FIG. 1 is a front-side perspective view of the storage-receptacle during an ‘in-use’ condition, according to an embodiment of the disclosure.

FIG. 2 is a front-side perspective view of the storage-receptacle of FIG. 1, according to an embodiment of the present disclosure.

FIG. 3 is a top perspective view of the storage-receptacle of FIG. 1, according to an embodiment of the present disclosure.

FIG. 4 is a bottom-side perspective view of the storage-receptacle of FIG. 1, according to an embodiment of the present disclosure.

FIG. 5 is a flow diagram illustrating a method of use for the storage-receptacle, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a receptacles and more particularly to a ladder storage receptacle as used to improve the efficiency of storage of items while using a ladder.

Generally disclosed is a tool box including securement straps designed to be installed on the top of a ladder. The tool box may allow for quick, convenient, and safe access to numerous tools and materials needed to complete a job while working on ladders. The tool box may utilize hook and loop fastener straps on an underside of the box in order to firmly attach the tool box to a top step of the ladder, thus, eliminating the need for individuals to constantly step up and down a ladder to retrieve new tools or worksite materials.

The tool box may be a U-shaped storage container featuring ample space to store multiple tools and materials. Further, the tool box may include a carrying handle, and utilize the hook and loop fastener straps on the underside of the box in order to be firmly secured to the ladder. Users may place tools and materials within the box and climb a ladder. The box may be secured to the top step/rung via the hook and loop fastener straps. In addition, the tool box may slip over the top step/rung of the ladder snuggly, substantially eliminating the worry of tools and materials becoming loose while working.

The tool box may be constructed using plastic, wood, and other suitable materials. The overall width on the outside edges may measure approximately 26.75″, and overall length, from front to back, may measure approximately 12″. The box may measure approximately 5″ in depth in order to properly accommodate tools and materials. Exact size, measurement, construction, and design specifications may vary upon manufacturing.

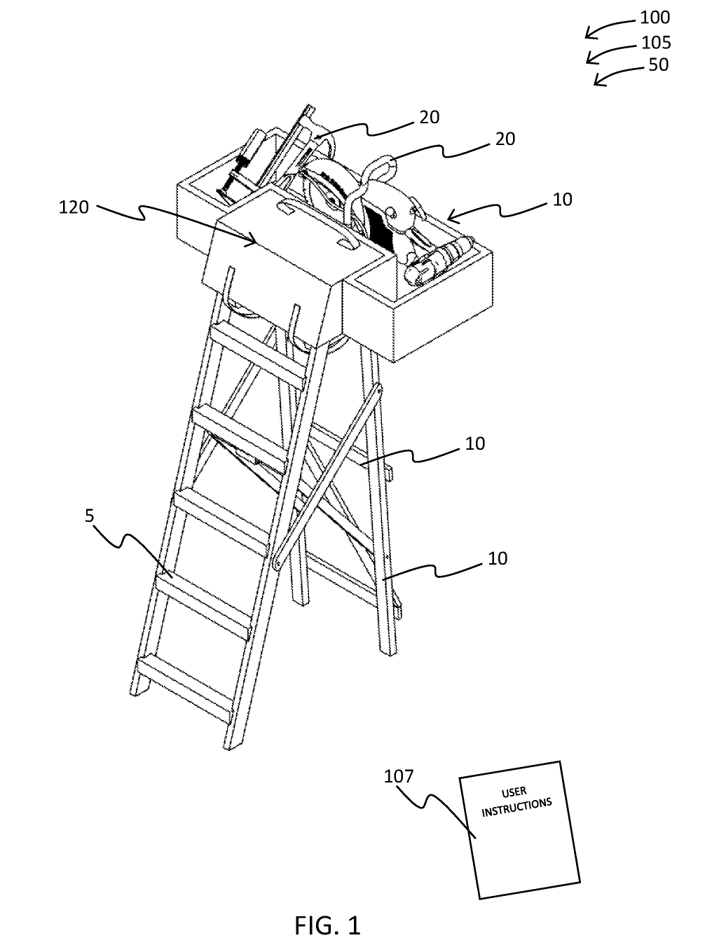

Referring now more specifically to the drawings by numerals of reference, there is shown in FIGS. 1-4, various views of a storage-receptacle 100.

FIG. 1 shows a storage-receptacle 100 during an ‘in-use’ condition 150, according to an embodiment of the present disclosure. As Illustrated, the storage-receptacle 100 may include a tray-housing 110 and an attachment-means 120. As shown, the storage-receptacle 100 for attachment to a ladder 5, the ladder 5 including a plurality of steps 10 having at least one top-step 15.

According to one embodiment, the storage-receptacle 100 may be arranged as a kit. The kit may include a set of user instructions. The instructions may detail functional relationships in relation to the structure of the storage-receptacle 100 (such that the storage-receptacle 100 can be used, maintained, or the like, in a preferred manner).

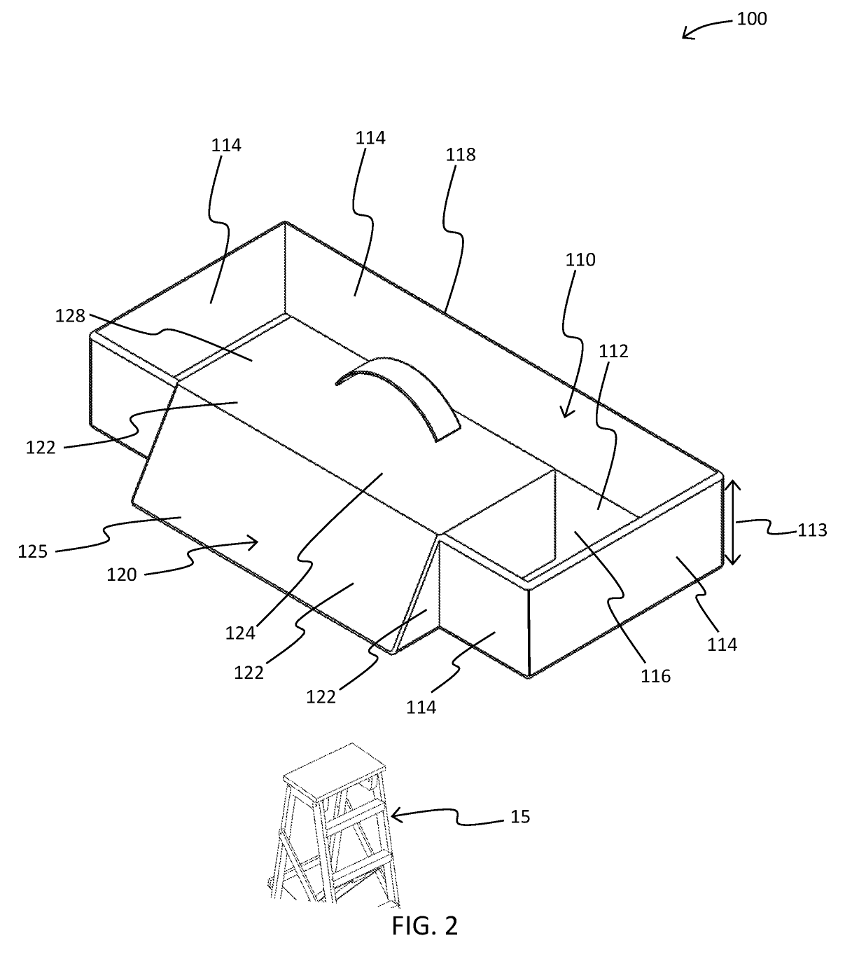

Referring now to FIG. 2 showing a front-side perspective view of the storage-receptacle 100 of FIG. 1, according to an embodiment of the present disclosure. As shown, the tray-housing 110 may include a tray-capacity 112 defined by at least four tray-sides 114, a tray-base 116 and an open-top 118 opposite the tray-base 116 and relative to the ladder. The tray-capacity 112 may be configured to store a plurality of items 20 therein (FIG. 1). As illustrated, the tray-housing 110 may include a three-dimensional rectangular shape. Further, the tray-capacity 112 includes a tray-depth 113 of at least 5 inches.

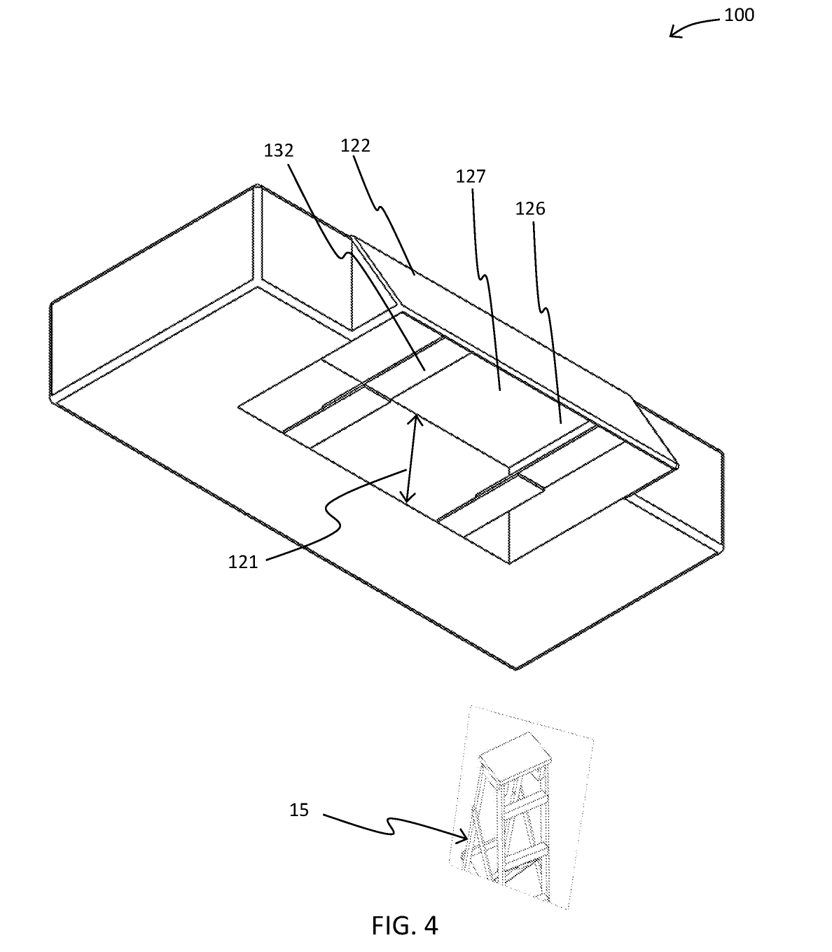

The attachment-means 120 may be fixedly-attached to one of the at least four tray-sides 114, the attachment-means 120 including at least four attachment-sides 122, an attachment-top 124 and an open-bottom 126 (FIG. 4) opposite the attachment-top 124 and relative to the ladder, the open-bottom 126 (FIG. 4) being configured for securement over the at least one top-step 15. As shown and as above, the attachment-means 120 may include the three-dimensional rectangular-shape. In addition, one of the at least four attachment-sides 122 may include a slanted-side 125 and the slanted-side 125 may include an angle of at least 18 degrees. Further, as shown the attachment-top 124 may include a flat-surface 128 configured to hold at least one of the pluralities of items 20 during use of the ladder.

In a preferred embodiment, the tray-housing 110 may include a tray-length of at least 28⅛ inches, and the attachment-means 120 may include an attachment-length of at least 16⅜ inches. Further, the tray-housing 110 may include a tray-width of at least 12¼ inches. In this embodiment, a length from a rear-side of the tray-housing 110 and a front-side of the attachment-means 120 may be 15½ inches. However, other measurements may be used.

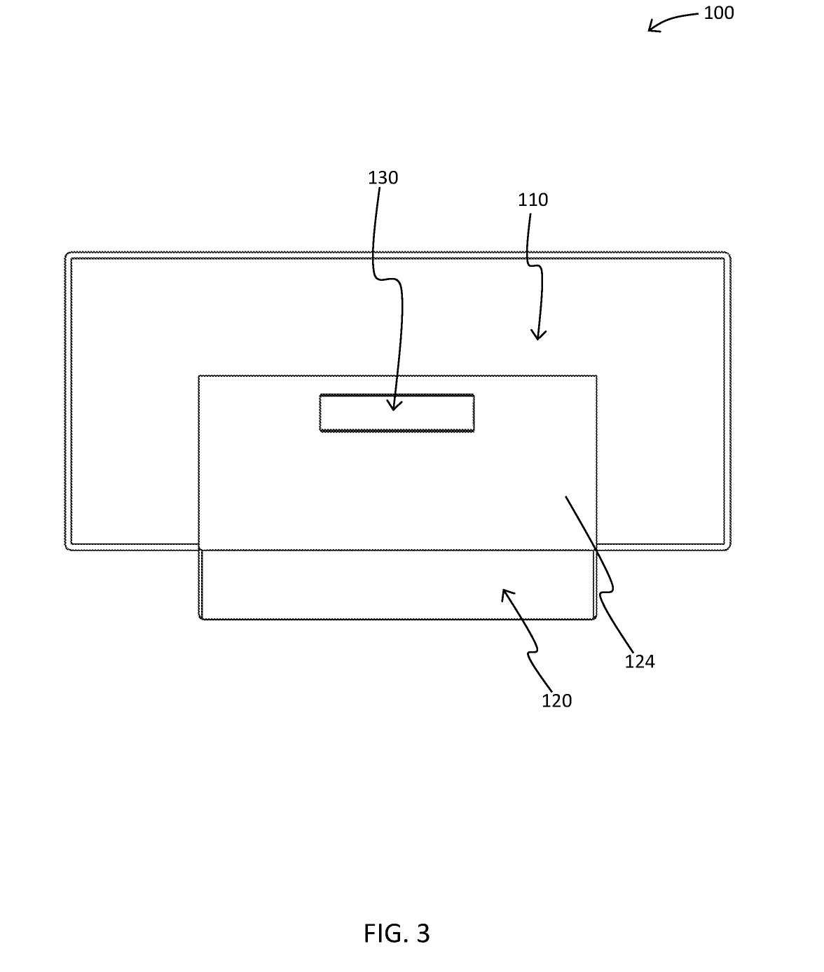

FIG. 3 shows a top perspective view of the storage-receptacle 100 of FIG. 1, according to an embodiment of the present disclosure. As shown, the storage-receptacle 100 may further include a handle 130 attached to the attachment-top 124 and configured to aid in portability of the storage-receptacle 100. In a preferred embodiment, the tray-housing 110 and the attachment-means 120 may include a plastic material. In another embodiment, the tray-housing 110 and the attachment-means 120 may include a wood-material. However, it should be appreciated that other materials may be used. The plastic-material may be a thermosetting plastic to provide durability and strength. In some embodiments, the wood-material may be a plywood material. However, other materials may be used.

Referring now to FIG. 4 showing a bottom-side perspective view of the storage-receptacle 100 of FIG. 1, according to an embodiment of the present disclosure. The at least four attachment-sides 122 and the attachment-top 124 (FIG. 3) may define a ladder-capacity 127 and the ladder-capacity 127 may be sized to receive and securely retain the at least one top-step 15 of the ladder. In one embodiment, the ladder-capacity 127 may include a ladder-depth 121 of the at least 5 inches.

As illustrated, at least one of the open-bottom 126 and the at least four attachment-walls may include at least one fastener 132 configured to aid in the securement of the open-bottom 126 over the at least one top-step 15 of the ladder. In a preferred embodiment, the at least one fastener 132 may located on the slanted-side 125. Further, in the preferred embodiment, the at least one fastener 132 may be two strips of hook and loop fastener 132. However, other fasteners 132 may be used. For example, snap fastener, hook and eye fasteners, and the like.

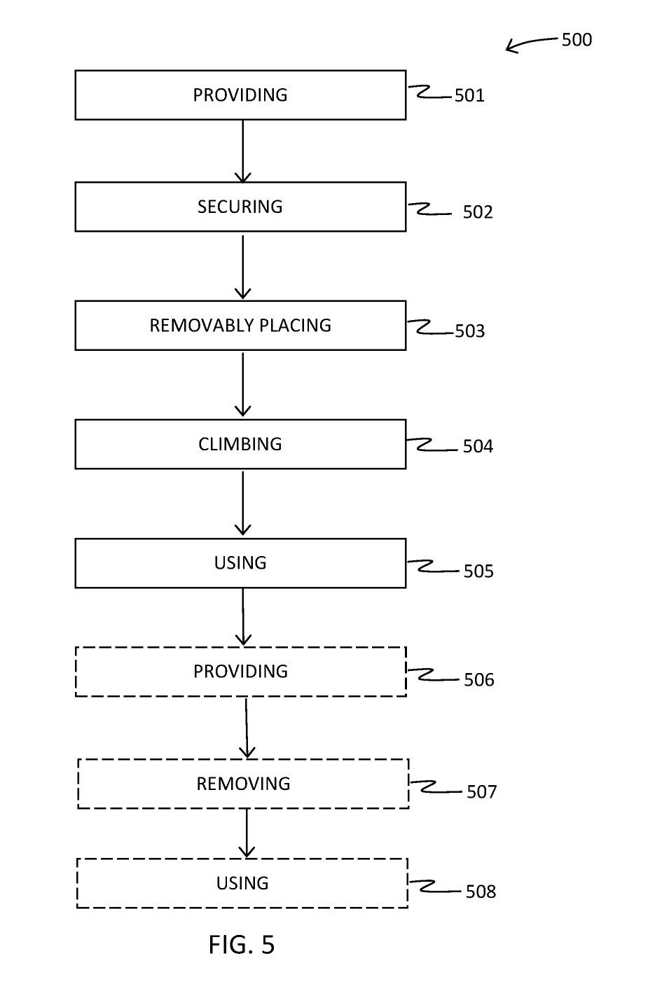

FIG. 5 is a flow diagram 550 illustrating a method of using a storage-receptacle on a ladder 500, according to an embodiment of the present disclosure. As illustrated, the method of using a storage-receptacle on a ladder 500 may include the steps of: step one 501, providing the storage-receptacle 100 as above; step two 502, securing the attachment-means 120 over the at least one top-step 15 of the ladder via the open-bottom 126; step three 503, removably-placing at least one of the plurality of items 20 into the tray-capacity 112 of the tray-housing 110; step four 504, climbing the plurality of steps 10 of the ladder 5; and step five 505, using the at least one of the plurality of items 20 whilst on the ladder 5. Further steps may include; step six 506, providing the storage-receptacle 100 further including a handle 130 attached to the attachment-top 124; step seven 507, removing the storage-receptacle 100 from the at least one top-step 15 of the ladder 5; and step eight 508, using the handle 130 to transport the storage-receptacle 100.

It should be noted that step six 506, step seven 507 and step eight 508 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for” in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for storage-receptacle 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A storage-receptacle for attachment to a ladder, the ladder including a plurality of steps having at least one top-step, the storage-receptacle comprising:
a tray-housing including a tray-capacity defined by at least four tray-sides, a tray-base and an open-top opposite the tray-base and relative to the ladder, the tray-capacity being configured to store a plurality of items therein; and
an attachment-means fixedly-attached to one of the at least four tray-sides, the attachment-means including at least four attachment-sides, an attachment-top and an open-bottom opposite the attachment-top and relative to the ladder, the open-bottom being configured for securement over the at least one top-step.

2. The storage-receptacle of claim 1, further comprising a handle attached to the attachment-top and configured to aid in portability of the storage-receptacle.

3. The storage-receptacle of claim 1, wherein the at least four attachment-sides and the attachment-top define a ladder-capacity.

4. The storage-receptacle of claim , wherein the ladder-capacity is sized to receive and securely retain the at least one top-step of the ladder.

5. The storage-receptacle of claim 1, wherein the tray-housing includes a three-dimensional rectangular shape.

6. The storage-receptacle of claim 5, wherein the attachment-means includes the three-dimensional rectangular-shape.

7. The storage-receptacle of claim 1, wherein the attachment-top includes a flat-surface configured to hold at least one of the plurality of items during use of the ladder.

8. The storage-receptacle of claim 1, wherein the tray-capacity includes a tray-depth of at least 5 inches.

9. The storage-receptacle of claim 1, wherein the ladder-capacity includes a ladder-depth of the at least 5 inches.

10. The storage-receptacle of claim 1, wherein one of the at least four attachment-sides includes a slanted-side.

11. The storage-receptacle of claim 10, wherein the slanted-side includes an angle of at least 18 degrees.

12. The storage-receptacle of claim 1, wherein at least one of the open-bottom and the at least four attachment-walls includes at least one fastener configured to aid in the securement of the open-bottom over the at least one top-step of the ladder.

13. The storage-receptacle of claim 12, wherein the at least one fastener is two strips of hook and loop fastener.

14. The storage-receptacle of claim 13, wherein the at least one fastener is located on the slanted-side.

15. The storage-receptacle of claim 1, wherein the tray-housing and the attachment-means includes a plastic-material.

16. The storage-receptacle of claim 1, wherein the tray-housing and the attachment-means includes a wood-material.

17. A storage-receptacle for attachment to a ladder, the ladder including a plurality of steps haying at least one top-step, the storage-receptacle comprising:
a tray-housing including a tray-capacity defined by at least four tray-sides, a tray-base and an open-top opposite the tray-base and relative to the ladder, the tray-capacity being configured to store a plurality of items therein;
an attachment-means fixedly-attached to one of the at least four tray-sides, the attachment-means including at least four attachment-sides, an attachment-top and an open-bottom opposite the attachment-top and relative to the ladder, the open-bottom being configured for securement over the at least one top-step; and
a handle attached to the attachment-top and configured to aid in portability of the storage-receptacle; and
wherein the at least four attachment-sides and the attachment-top define a ladder-capacity;
wherein the ladder-capacity is sized to receive and securely retain the at least one top-step of the ladder;
wherein the tray-housing includes a three-dimensional rectangular shape;
wherein the attachment-means includes the three-dimensional rectangular-shape;
wherein the attachment-top includes a fiat-surface configured to hold at least one of the plurality of items during use of the ladder;
wherein the tray-capacity includes a tray-depth of at least 5 inches;
wherein the ladder-capacity includes a ladder-depth of the at least 5 inches;
wherein one of the at least four attachment-sides includes a slanted-side;
wherein the slanted-side includes an angle of at least 18 degrees;
wherein at least one of the open-bottom and the at least four attachment-wails includes at least one fastener configured to aid in the securement of the open-bottom over the at least one top-step of the ladder;
wherein the at least one fastener is two strips of hook and loop fastener;
wherein the at least one fastener is located on the slanted-side; and
wherein the tray-housing and the attachment-means includes a plastic-material.

18. The storage-receptacle of claim 17, further comprising set of instructions; and
wherein the storage-receptacle is arranged as a kit.

19. A method of using a storage-receptacle on a ladder, the ladder including a plurality of steps haying at least one top-step, the method comprising the steps of:
providing the storage-receptacle for attachment to a ladder, the storage-receptacle including:
a tray-housing including a tray-capacity defined by at least four tray-sides, a tray-base and an open-top opposite the tray-base and relative to the ladder, the tray-capacity being configured to store a plurality of items therein; and
an attachment-means fixedly-attached to one of the at least four tray-sides, the attachment-means including at least four attachment-sides, an attachment-top and an open-bottom opposite the attachment-top and relative to the ladder, the open-bottom being configured for securement over the at least one top-step;
securing the attachment-means over the at least one top-step of the ladder via the open-bottom;
removably-placing at least one of the plurality of items into the tray-capacity of the tray-housing;
climbing the plurality of steps of the ladder; and
using the at least one of the plurality of items whilst on the ladder.

20. The method of claim 19, further comprising the steps of:
providing the storage-receptacle further including a handle attached to the attachment-top;
removing the storage-receptacle from the at least one top-step of the ladder; and
using the handle to transport the storage-receptacle.
